(19) United States
(12) Patent Application Publication
(10) Pub. No.: US 2009/0243369 A1
(43) Pub. Date: Oct. 1, 2009

(54) LEAVEITCLEAN.ORG MOBILE RECYCLING CENTER

(76) Inventor: BRIAN FICK, Bourbonnais, IL (US)

Correspondence Address: James Ray & Associates, 2640 Pitcairn Road, Monroeville, PA, 15146, US

(21) Appl. No.: 12/414,724

(22) Filed: Mar. 31, 2009

Related U.S. Application Data
(60) Provisional application No. 61/040,954, filed on Mar. 31, 2008.

(51) Int. Cl. B60P 1/56; B60D 1/04; B65D 21/00

(52) U.S. Cl. 298/8 H; 280/514; 220/23.83

(57) ABSTRACT

The present invention includes a predetermined number of bins, constructed to accept one type of material in each bin. Each bin may have an easy to use deposit door. Each bin may be labeled to distinguish which particular material can be deposited into a particular bin. The internal components inside each bin allows for compacting, bundling, or chipping of the materials, or some combination thereof, into bins for storage until they are removed. The present invention can be moved as needed or set in a designated area. The bins slide out and dump making it easy for the user to empty the compacted, chipped, or bundled materials.

### CROSS REFERENCE TO RELATED APPLICATION

This patent application is related to and claims priority from U.S. Provisional Patent Application Ser. No. 61/040,954 filed Apr. 1, 2008.

### FIELD OF THE INVENTION

The present invention relates, in general, to refuse recycling separation and collection containers for separated materials and, more particularly, this invention relates to mobile recycling containers that allow for compacting, bundling, and/or chipping of materials into separated bins.

### BACKGROUND OF THE INVENTION

Prior to the conception and development of the present invention, and as is generally well known in the prior art, separated bins or other containers have been used to collect a variety of recyclable materials. Different materials need to be processed differently, therefore it is more efficient and less costly to have the materials separated into separate containers. Typically these containers are nothing more than labeled containers that are emptied periodically much like a trash dumpster.

Many forms of recyclable materials are of low density and take up a great deal of room in the containers. This requires the collection containers to be very large or to be emptied frequently. Both of these limitations in the prior art make the collection of recyclable material less feasible to many. The present invention facilitates the compacting, bundling, and chipping of materials for storage, allowing more material to be stored in the collection bins before the bins need to be emptied. The present invention also allows for the collection of recyclable material and refuse in any location a tow trailer can be placed.

### SUMMARY OF THE INVENTION

The present invention, in one embodiment, is an enclosed tow trailer that allows for recyclable material collection in virtually any location. The present invention, in another embodiment, is a truck with an enclosed recyclable material collection center. The present invention includes a predetermined number of bins, constructed to accept one type of material in each bin. Each bin may have an easy to use deposit door. Each bin may be labeled to distinguish which particular material can be deposited into a particular bin. The internal components inside each bin allows for compacting, bundling, or chipping of the materials, or some combination thereof. The material is then placed into bins for storage until the bins are removed. The present invention can be moved as needed or placed in a designated area. The bins slide out and dump making it easy for the user to empty the compacted, chipped, or bundled materials.

### OBJECTS OF THE INVENTION

It is, therefore, one of the primary objects of the present invention to provide a portable recycling center that enables a larger amount of material to be collected in the finite space of a tow trailer.

Another object of the present invention is to provide a portable recycling center that can be towed by a pickup truck.

Still another object of the present invention is to provide a portable recycling center that can be placed in a greater variety of locations than traditional collection bins.

In one embodiment the invention is a tow trailer comprising: at least one axel with at least two wheels associated with said at least one axel, at least one tow hitch, at least two storage bins, at least one chipping device for breaking material into smaller pieces for storage into a first storage bin, at least one compacting device for compacting material for storage into a second storage bin, wherein the first storage bin and the second storage bin store different recyclable materials.

In another embodiment the invention is an enclosed tow trailer comprising at least one axel with at least two wheels associated with said at least one axel, at least one tow hitch, at least one compacting device for compacting material for storage into a first storage bin, at least one bundling device for bundling material for storage into a second storage bin, wherein the first storage bin and the second storage bin store different recyclable materials.

In yet another embodiment the invention is a vehicle comprising: at least one axel with at least two wheels associated with said at least one axel, at least two storage bins, at least one chipping device for breaking material into smaller pieces for storage into a first storage bin, at least one compacting device for compacting material for storage into a second storage bin, wherein the first storage bin and the second storage bin store different recyclable materials.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of one embodiment of the present invention.

FIG. 2 is a cutaway view of one embodiment of a chipper and associated storage bin.

FIG. 3 is a cutaway view of one embodiment of a bundler and associated storage bin.

FIG. 4 is a cutaway view of one embodiment of a compactor and associated storage bin.

FIG. 5 is cutaway view of one embodiment of a storage bin with its retaining arms extended, prepared to dump its contents.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

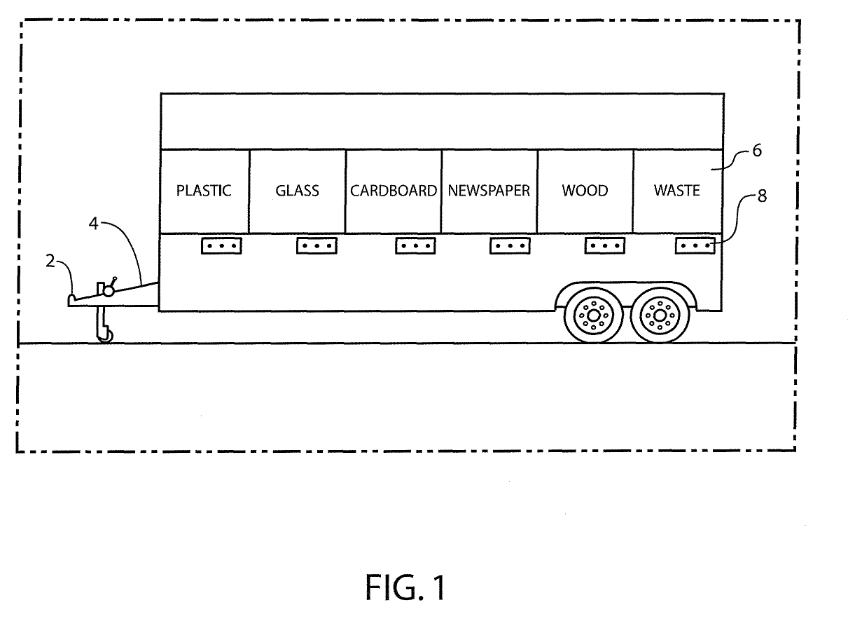

Reference is now made, more particularly, to FIG. 1 which shows the external features of this embodiment of the present invention. In this embodiment the invention is a tow trailer with tow hitch 2 attached to the tongue 4 of the tow trailer. The trailer frame has two axels with wheels attached to the axels. Bin doors 6 cover their respective deposit slots for depositing material to be stored into the respective bin. Bin doors 6 can be labeled to indicate the material that should be deposited in each bin. The user interface 8 for each bin is located proximately to the respective bin door 6. The user interface 8 could include controls for initiating compacting, chipping or bundling, depending on the internal components of the bin being used. The user interface 8 could also include stop or emergency stop controls, for stopping the function of the respective bin or the entire trailer. A safety interlock (not shown) could be integrated into the user interface 8 to prevent operation of the user interface if the respective bin door 6 is not properly closed.

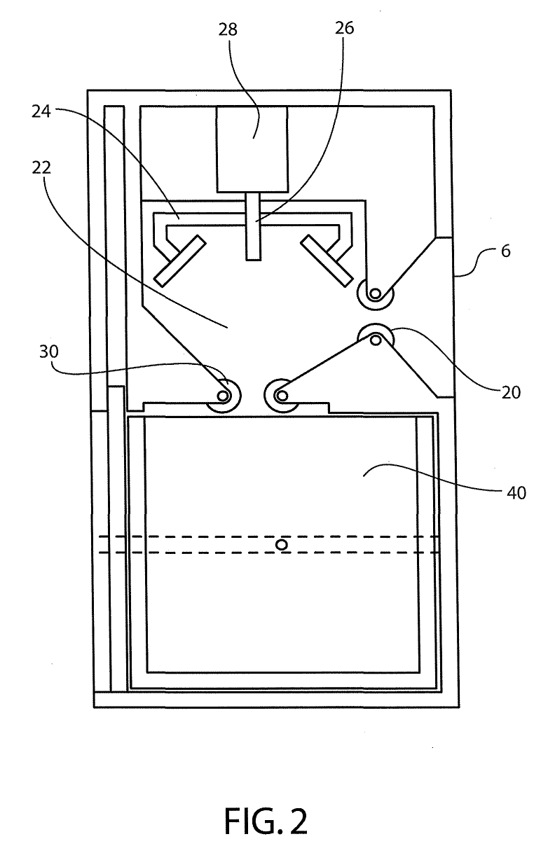

Reference is now made to FIG. 2, which shows a cutaway view of one embodiment of a chipping device and storage bin. The bin door 6 covers feeding rollers 20 which feed material into the chipping chamber 22 to be chipped by chipping bit 24. Chipping bit 24 is attached to shaft 26 which is rotated by motor 28. Motor 28 could be any acceptable motor known in the art, but preferably motor 28 is an electric motor. Process rollers 30 facilitate removal of chipped material from chipping chamber 22. Process rollers 30 may be narrowly spaced to partially compact chipped material. Storage bin 40 is positioned to receive chipped material from process rollers 30.

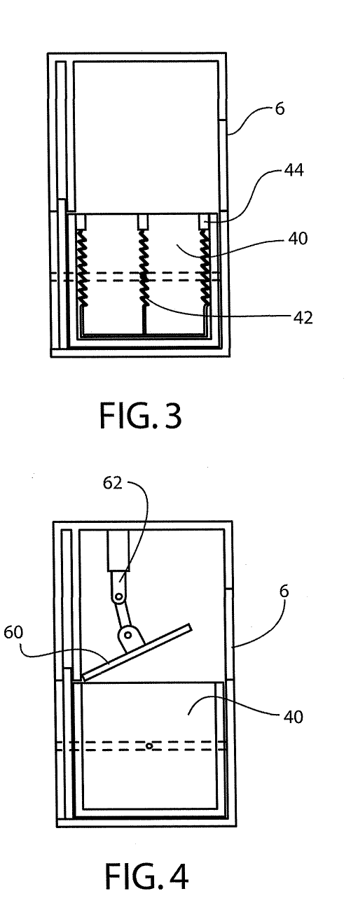

Reference is now made to FIG. 3, which shows a cutaway view of one embodiment of a bundling device and storage bin. The bin door 6 covers an opening to storage bin 40. Binding material 42 is held in place by tie hooks 44, wherein the bundling material is positioned to facilitate bundling by the user.

Reference is now made to FIG. 4, which shows a cutaway view of one embodiment of a compacting device and storage bin. The bin door 6 covers an opening to storage bin 40. Compactor plate 60 may be operatively connected to hydraulic arm 62. Hydraulic arm 62 could be manually powered by means of a hydraulic foot pedal or could be enabled with motorized hydraulic actuation or the like.

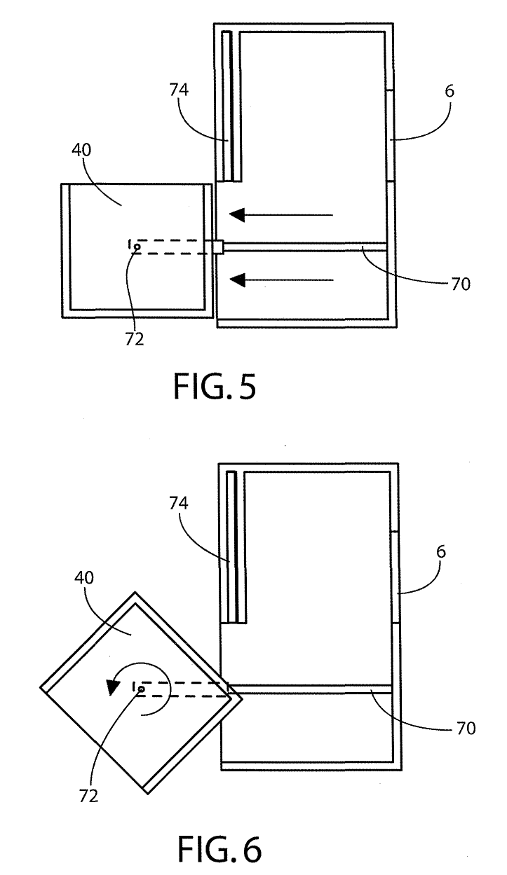

Reference is now made to FIG. 5, which shows a cutaway view of one embodiment of a dumping storage bin. Storage bin 40 is operatively connected to telescopic guide rails 70 which may be secured to the trailer frame and or the enclosure frame. Storage bin 40 is connected to telescopic guide rails 70 by bearings 72 so that storage bin 40 can be dumped. Rear hatch 74 slides open allowing for removal and/or dumping of storage bin 40.

Reference is now made to FIG. 6, which shows a cutaway view of one embodiment of a dumping storage bin being dumped. Storage bin 40 is operatively connected to telescopic guide rails 70 which may be secured to the trailer frame and or the enclosure frame. Storage bin 40 is connected to telescopic guide rails 70 by bearings 72 so that storage bin 40 can be dumped. Rear hatch 74 slides open allowing for removal and/or dumping of storage bin 40.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A tow trailer comprising:
at least one axel with at least two wheels associated with said at least one axel,
at least one tow hitch,
at least two storage bins,
at least one chipping device for breaking material into smaller pieces for storage into a first storage bin, at least one compacting device for compacting material for storage into a second storage bin,
wherein the first storage bin and the second storage bin store different recyclable materials.

2. A tow trailer as in claim 1, further comprising at least one bundling device for bundling material for storage into a third storage bin.

3. A tow trailer as in claim 1, further comprising a third storage bin.

4. A tow trailer as in claim 1, further comprising a storage bin for the collection of waste material.

5. A tow trailer as in claim 1, wherein said at least two storage bins are each connected to telescopic guide rails.

6. A tow trailer as in claim 1, wherein said at least two storage bins are emptied by dumping.

7. An enclosed tow trailer comprising:
at least one axel with at least two wheels associated with said at least one axel,
at least one tow hitch,
at least one compacting device for compacting material for storage into a first storage bin,
at least one bundling device for bundling material for storage into a second storage bin,
wherein the first storage bin and the second storage bin store different recyclable materials.

8. An enclosed tow trailer as in claim 7, further comprising at least one chipping device for chipping material for storage into a third storage bin.

9. An enclosed tow trailer as in claim 7, further comprising a third storage bin.

10. An enclosed tow trailer as in claim 7, further comprising a storage bin for the collection of waste material.

11. An enclosed tow trailer as in claim 7, wherein said at least two storage bins are each connected to telescopic guide rails.

12. An enclosed tow trailer as in claim 7, wherein said first storage bin and said second storage bin are capable of being emptied by dumping.

13. A vehicle comprising:
at least one axel with at least two wheels associated with said at least one axel,
at least two storage bins,
at least one chipping device for breaking material into smaller pieces for storage into a first storage bin, at least one compacting device for compacting material for storage into a second storage bin,
wherein the first storage bin and the second storage bin store different recyclable materials.

14. A vehicle as in claim 13, further comprising at least one bundling device for bundling material for storage into a third storage bin.

15. A vehicle as in claim 13, further comprising a third storage bin.

16. A vehicle as in claim 13, further comprising a storage bin for the collection of waste material.

17. A vehicle as in claim 13, wherein said at least two storage bins are each connected to telescopic guide rails.

18. A vehicle as in claim 13, wherein said first storage bin and said second storage bin are capable of emptying by dumping.
